(19) United States
(12) Patent Application Publication
(10) Pub. No.: US 2014/0238204 A1
(43) Pub. Date: Aug. 28, 2014

(54) TOOL FOR FITTING AND REMOVING SCREW MEANS ON A REAR SIDE OF AN OBJECT

(71) Applicants: Patrik Rönnqvist, Norrkoping (SE); Conny Löfholm, Enhorna (SE)

(72) Inventors: Patrik Rönnqvist, Norrkoping (SE); Conny Löfholm, Enhorna (SE)

(73) Assignee: SCANIA CV AB, Södertälje (SE)

(21) Appl. No.: 14/347,761

(22) PCT Filed: Sep. 25, 2012
(86) PCT No.: PCT/SE2012/051012

§ 371 Date: Mar. 27, 2014

(30) Foreign Application Priority Data
Sep. 29, 2011 (SE) 1150897-5

(51) Int. Cl. B25B 13/48

(52) U.S. Cl. CPC B25B 13/481
USPC 81/73

(57) ABSTRACT

A tool (1) for fitting and removing a screw (2) situated on a rear side (3a) of an object (3). The tool (1) has a first straight section (1a) by which a turning movement may be imparted to the tool (1), a second straight and coaxial section (1c) provided with a socket (8) for being fastened on the screw (2), and a connecting section (1b) between the first straight section (1a) and the second straight section (1c). The connecting section (1b) has a crank shape so that it can reach round the object (3) and convert turning movements of the first straight section (1a) at a position in front of the object (3) to turning movements of the second straight section (1c) and the screw (2) on the rear side of the object (3). The first straight section (1a) and the second straight section (1c) are turnable about a common axis (9).

### BACKGROUND TO THE INVENTION AND PRIOR ART

The present invention relates to a tool for fitting and removing screw means on a rear side of an object according to the preamble of claim 1.

Brake yokes in vehicles are often incorporated in the vehicle's wheel housings and fastened by means of a number of screws situated on the rear side of the brake yoke. This results in difficulties of access for fitting and releasing the brake yoke with conventional tools such as socket wrenches or torque wrenches with associated extenders in the form of ratchet handles or the like. To release a brake yoke during servicing or repair operations, a fitter has usually to reach into the wheel housing and loosen the screws by means of an impact wrench. The fitter is thus compelled to work in a ergonomically disadvantageous posture. Releasing a brake yoke in this way is also time-consuming. When the brake yoke is to be fitted back in the wheel housing, access is difficult and torque wrenches are also difficult to use, since the space in the wheel housing is very limited. It is desirable to use torque wrenches in order to ensure that all of the screws are tightened with sufficient torque to ensure that the brake yoke is securely in position.

U.S. Pat. No. 6,089,128 refers to a tool for reaching and unfastening nuts of an engine fastening in a vehicle without having to remove adjacent components in the engine space. The tool has an elongate stem leading at one end to an angled section. The angled section ends with a head which comprises a recess for gripping a nut. The elongate stem has at an opposite end a recess for detachable connection of a ratchet handle. This means that the angled section can be moved down into a narrow space and caused to engage with the nut. By turning the ratchet handle to and fro, a turning movement can be imparted to the tool in a direction which unfastens the nut.

### SUMMARY OF THE INVENTION

The object of the present invention is to propose a tool which can reach and release screw means on a rear side of an object in a relatively easy and reliable way.

This object is achieved with the tool of the kind mentioned in the introduction which is characterised by the features indicated in the characterising part of claim 1. Where the object is situated in a narrow space, the rear side of the object is the side which faces away from an aperture to the space through which the tool is inserted. The rear side of the object thus also faces away from a fitter using the tool. The tool comprises a first straight section by which the fitter imparts a turning movement to the tool, a second straight section provided with a socket which the fitter fastens on the screw means, and a connecting section which serves as connection between the first straight section and the second straight section. The connecting section has a cranked shape so that it can reach round said object to make it possible to transfer turning movements from the first straight section to the second straight section and hence to the screw means on the rear side of the object. According to the invention, the first straight section and the second straight section are turnable about a common axis of rotation. Consequently, only a short linear movement corresponding to the linear movement of the screw means along the common axis is imparted to the first straight section, which therefore undergoes no sideways movements when the screw means is being fastened or released. This means that no lever arm action occurs between the first straight section and on the second straight section, resulting in the same torque on the first straight section and on the second straight section. The torque acting upon the screw means will thus be identical with that which a fitter imparts to the first straight section. The lack of lateral movements of the first straight section also facilitates the connecting of a lever arm or the like to impart a torque to the first straight section.

According to an embodiment of the present invention the socket is fitted detachably on the second straight section and can therefore easily be replaced by other sockets suited to accommodating screw means of other sizes and shapes. The screw means comprises with advantage a flanged head, and the socket has a recess of a size suited to accommodating the flanged head of the screw means. The screw means has with advantage a hexagonal head and the socket a correspondingly shaped recess.

According to another preferred embodiment of the present invention, the connecting section is made of hardened material forming a substantially rigid unit to transfer turning movements from the first straight section to the second straight section. This means that the tool undergoes substantially no bending movements even when conveying large torques to the screw means. A rigid tool is also a requirement for it to be possible for the first straight section and the second straight section to turn about a common axis.

According to a preferred embodiment of the present invention, the connecting section has a first straight portion which is connected to the first turning section via a first curved transition and which forms an angle of substantially 90° with the common axis. Such a straight portion results in the tool being at a rapidly increasing distance from the common axis, thereby enhancing its ability to reach round the object. The presence of the curved transition between said straight portion and the first straight section reduces the amount of stresses in this part of the tool. The connecting section may have a second straight portion which is connected to the first straight portion via a second curved transition and which has an extent substantially parallel with the common axis. The distance between the straight second portion and the common axis defines the ability of the tool to reach round an object. The fact that the second portion is straight makes it possible for the tool to be moved along the common axis without reducing its ability to reach round an object. The connecting section may have a third straight portion which is connected to the second straight portion via a third curved transition and which forms an angle of substantially 90° with the common axis. With such a third straight portion the tool will be at a rapidly reduced distance from the common axis, thereby enhancing its ability to reach into a narrow passage on the rear side of the object and be fastened on the screw means.

According to a preferred embodiment of the present invention, the first straight section is connected to a lever arm mechanism which imparts a turning movement to it. The lever arm mechanism is preferably arranged for movement in a plane perpendicular to the common axis. In one alternative the lever arm takes the form of a fixed part of the tool. In another alternative, the first straight section has a connecting means making it possible to connect a separate lever arm which is with advantage a ratchet handle. The ratchet handle may thus be connected detachably to the tool. Ratchet handles are usually provided with a locking device so that pivoting the ratchet handle to and fro within a limited angular range is sufficient to impart a turning movement to the tool in one direction. Changing between tightening and unfastening may be achieved by using a switching means on the ratchet handle or by the ratchet handle being subjected to a half-turn about its longitudinal axis. The ratchet handle also has with advantage a torque limiter by which a desired torque can be set, thus ensuring that all of the screw means are tightened with the desired torque.

According to an embodiment of the present invention, the tool is suited to fitting and removing screw means situated on a rear side of a brake yoke in a wheel housing of a vehicle. Brake yokes in vehicles are often fastened by means of a number of screws on the rear side, i.e. the side of a brake yoke which faces away from the wheel housing aperture which is freed by removing the wheel. Inserting conventional tools and releasing and fastening brake yoke screws is complicated, time-consuming and inappropriate ergonomically because of the limited space in the wheel housing. The present tool substantially simplifies this work. It is also possible to use the tool according to the invention successfully in other contexts where similar problems occur.

According to an embodiment of the present invention, the first straight section has a surface appropriate to abutting against a bearing surface of a support means. The fact that the first straight section is in a substantially specific rotational position makes it possible to use a support means with a suitably shaped bearing surface under the first straight section. Such a bearing surface reduces the risk that the tool might slant and that the socket might thereby become detached from the screw means. The bearing surface has with advantage a curved concave shape, e.g. a V or U shape, in a plane perpendicular to the common axis. This provides assurance that the straight section will remain on the curved bearing surface when being turned. The support means has with advantage legs or similar contact devices so that it can stand stably on the substrate. The support means may be a pallet stand.

### BRIEF DESCRIPTION OF THE DRAWING

A preferred embodiment of the invention is described below by way of example with reference to the attached drawing, in which

FIG. 1 depicts a tool according to the present invention for fitting and removing screw means fastened on the rear side of a brake yoke in a wheel housing of a vehicle.

### DETAILED DESCRIPTION OF A PREFERRED EMBODIMENT OF THE INVENTION

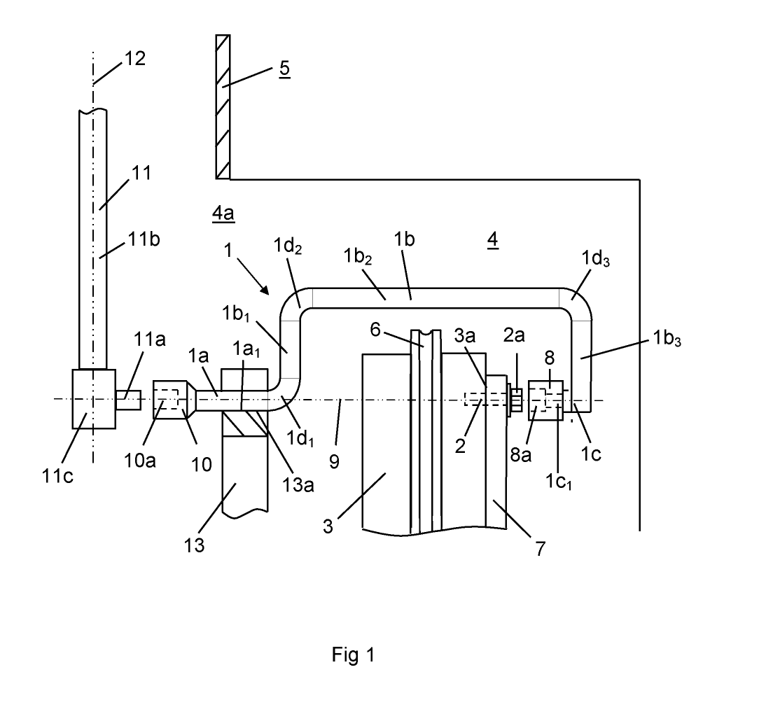

FIG. 1 depicts a tool 1 for fitting and removing an object fastened by screw means 2 on a rear side of the object. The tool is particularly suited to removing screw means fastened on the rear side 3a of a brake yoke 3 in a wheel housing 4 of a vehicle. The wheel housing has an aperture 4a defined by the vehicle's bodywork 5. This aperture to the wheel housing is clear when the wheel is removed. The brake yoke 3 is so positioned that it extends partly round a brake disc 6. The brake yoke is fastened with a number of screw means 2 in a schematically depicted fastening element 7 which may be situated on a wheelshaft of the vehicle. The wheel housing contains further components, e.g. a shock absorber, which limit the space in the wheel housing. For the sake of clarity, no such further components appear in FIG. 1. The brake yoke 3 is usually fastened by a plurality of screw means 2 in the wheel housing 4, although only one such screw means appears in FIG. 1. The screw means is provided with a flanged head 2a which has with advantage six sides.

The tool 1 comprises a first straight section 1a, a connecting section 1b which has a cranked shape so that it can reach round the brake yoke 3 and the brake disc 6, and a second straight section 1c which is provided with a bracket for detachable mounting of a socket 8. The socket has a recess 8a suited to accommodating the flanged head 2a of the screw means, for mutual joint rotation. The recess 8a has an aperture facing towards the first straight section 1a. The sleeve 8 may be replaced by sleeves of different sizes to cater for screw means with heads 2a of different sizes and shapes. The shape of the tool is such that the first straight section 1a and the second straight section 1c turn about a common axis 9 when the tool is used.

The cranked connecting section 1b comprises a first straight portion 1b₁ connected to the first straight section 1a via a first curved transition 1d₁. This first straight portion forms an angle of about 90° with the first straight section and the common axis 9. The connecting section comprises a second straight portion 1b₂ connected to the first straight portion 1b via a second curved transition 1d₂. The second straight portion 1b₂ has an extent substantially parallel with the common axis. The connecting section 1b comprises a third straight portion 1b₃ connected to the second straight portion 1b₂ via a third transition 1d₃. The third straight portion 1b₃ forms an angle of about 90° with the second straight section 1c and the common axis 9. The connecting section 1b is thus provided with a bend of about 90° at each of said transitions 1d₁, 1d₂, 1d₃. The tool 1 as a whole, particularly the connecting section 1b, is made of hardened material forming a rigid unit so that it can transfer turning movements from the first straight section 1a to the second straight section 1c via the cranked connecting section 1b.

The first straight section 1a has at a free end a connecting means 10 which it makes it possible to establish a detachable connection to a ratchet handle 11. This connecting means has a recess 10a suited to accommodating a protruding portion 11a of the ratchet handle when they are in a connected state. The shapes of the recess 10a and protruding portion 11a are such that a connection for mutual joint rotation is established between the first straight section 1a and the ratchet handle 11. The ratchet handle has a lever arm 11b arranged for movement in a plane 12 which is perpendicular to the common axis 9. This lever arm is connected to the protruding portion 11a via a housing 11c containing a mechanism which transfers to the protruding portion the lever arm's turning movements in one direction but not those in an opposite direction. A switching means may be used or the lever arm 11b be turned to and fro in said plane to cause the tool to rotate in a desired direction. The housing 11c contains also a built-in torque limiter.

When the brake yoke 3 is to be removed, the wheel in the wheel housing 4 is released, thereby clearing the aperture 4a to the wheel housing and the brake yoke. The tool 1 is then inserted in the wheel housing to the position depicted in FIG. 1, followed by fitting the socket 8 on the head 2a of the screw means. In this situation here again, a support 13, which may be a pallet stand, is placed under an external surface 1a₁ of the first straight section 1a. This support has a bearing surface 13a which is of concave shape in a plane perpendicular to the common axis 9. The support 13 has also with advantage legs so that it can stand stably on a substrate. The ratchet handle 11 is then connected to the tool 1 via the protruding portion 11a which is inserted into the recess 10a. The length of the tool is such that the ratchet handle will be outside the wheel housing aperture 4 and alongside the vehicle's bodywork 5 when in a connected state. This means that its lever arm 11b can be moved freely in the plane 12 without coming into contact with the vehicle. A fitter may thus stand in an upright posture beside the vehicle and release the brake yoke 3. The lever arm 11b is used to impart a torque such that the screw means 2 can easily be unfastened. The support 13 provides assurance that the tool will not slant and thereby become detached from the screw means when a fitter imparts a turning movement by means of the ratchet handle. After one screw means has been released the undepicted other screw means can be unfastened in a similar way.

When the brake yoke 3 is to be fitted, the screw means 2 are placed in their respective holes. The tool 1 is then inserted into the wheel housing 4 to a position from which the socket 8 can fitted on one of the heads 2a of the screw means. The ratchet handle 11 is then connected to the tool 1 if this has not already been done. The fitter sets an appropriate limiting torque for the ratchet handle. Here again, a support 13 of the kind mentioned above is with advantage placed under the tool's first straight section 1a so that the tool will not slant and thereby become detached from the screw means 12 when a fitter imparts a turning movement by means of the ratchet handle. As the lever arm 11b is outside the wheel housing aperture 4a, the fitter can stand beside the vehicle's bodywork 5 and tighten the screw means with the set torque. When one screw means has been fully tightened, the undepicted other screw means can be tightened in a similar way.

The present tool makes it possible for a fitter to work in an ergonomically favourable posture when both releasing and fitting the brake yoke 3. The tool 1 makes it possible to unfasten and tighten the brake yoke's screw means quickly with an appropriate torque. The interchangeable socket 8 makes it possible for the tool to be used for brake yokes of other makes. The tool is hardened to form a unit which is substantially rigid even when subject to substantial torques. As the first straight section 1a and second straight section 1c turn about a common axis 9, the same torque is imparted to the screw means 2 as to the first straight section. The fact that the first straight section does not undergo any sideways movements makes the ratchet handle 11 relatively easy to connect. The lack of lateral movements of the first straight section also makes it possible to use an underlying support 13 which further stabilises the position of the tool when in use.

The invention is in no way restricted to the embodiments described with reference to the drawings but may be varied freely within the scopes of the claims. The tool may be used to unfasten screw means on the rear side of any object. The cranked connecting section 1b may have substantially any cranked shape without straight portions.

1. A tool for fitting and removing a screw situated on a rear side of an object, the tool comprising:
a first straight section configured for imparting a turning movement to the tool;
a second straight section spaced axially from the first straight section, the second section provided with a socket which is configured for being fastened on the screw;
wherein the first straight section and the second straight section are turnable about a common axis; and
a connecting section which connects between the first straight section and the second straight section, the connecting section has a crank shape so that it can reach round the object and the crank shape converts turning movements of the first straight section at a position in front of the object to turning movements of the second straight section and the screw on the rear side of the object.

2. A tool according to claim 1, wherein the socket is detachably mounted on the second straight section.

3. A tool according to claim 1, further comprising:
when the screw has a flanged head, the socket has a recess of a size suited to accommodating the flanged head of the screw.

4. A tool according to claim 3, wherein the connecting section is made of a hardened material and thereby forms a substantially rigid unit which transfers turning movements from the first straight section to the second straight section.

5. A tool according to claim 1, wherein the connecting section comprises a first straight portion connected to the first straight section via a first curved transition and forming an angle of substantially 90° with the common axis.

6. A tool according to claim 5, wherein the connecting section comprises a second straight portion connected to the first straight portion via a second curved transition and the second straight portion has an extent substantially parallel with the common axis.

7. A tool according to claim 6, further comprising the connecting section comprises a third straight portion connected to the second straight portion via a third curved transition and forming an angle of substantially 90° with the common axis.

8. A tool according to claim 1, further comprising a lever arm mechanism which is connected to the first straight section, the lever arm mechanism is configured to impart a turning movement to the first straight section.

9. A tool according to claim 8, further comprising:
the first straight section has a connector configured to connect a lever arm in the form of a ratchet handle.

10. A tool according to claim 1, wherein the tool is configured for fitting and removing screws situated on a rear side of a brake yoke in a wheel housing of a vehicle.

11. A tool according to claim 1, wherein the first straight section has a surface configured for abutting against a bearing surface of a support therefor.
